(19) United States
(12) Patent Application Publication
(10) Pub. No.: US 2026/0255461 A1
(43) Pub. Date: Aug. 27, 2026

(54) EMISSION CONTROLLING CIRCUIT

(71) Applicant: ASMedia Technology Inc., New Taipei City (TW)

(72) Inventor: Chun-Jung Hsu, New Taipei City (TW)

(73) Assignee: ASMedia Technology Inc., New Taipei City (TW)

(21) Appl. No.: 19/078,309

(22) Filed: Mar. 13, 2025

(30) Foreign Application Priority Data
Feb. 26, 2025 (TW) 114107183

(51) Int. Cl. H05B 47/165; H05B 47/105; H05B 47/18

(52) U.S. Cl. CPC H05B 47/165; H05B 47/105; H05B 47/18

(57) ABSTRACT

The invention provides an emission controlling circuit capable of increasing an efficiency and a diversity of a light effect of an electronic device. The electronic device includes a host controlling circuit, an emission driving circuit, and a plurality of terminal devices. The emission controlling circuit includes an accelerator and a controller. The accelerator is coupled to the host controller and the plurality of terminal devices. The accelerator generates a passive output result according to input data from the plurality of terminal devices. The controller is coupled to the accelerator and the emission driving circuit. The controller generates a passive controlling instruction according to the passive output result, such that the emission driving circuit drives the plurality of terminal devices based on the passive controlling instruction to generate the light effect.

### CROSS-REFERENCE TO RELATED APPLICATION

This application claims the priority benefit of Taiwan application serial no. 114107183, filed on Feb. 26, 2025. The entirety of the above-mentioned patent application is hereby incorporated by reference herein and made a part of this specification.

### BACKGROUND OF THE INVENTION

### Field of the Invention

The invention relates to a controlling circuit, and in particular to an emission controlling circuit suitable for controlling the light effect of an electronic device.

### Description of Related Art

In general, a peripheral device used by a host may be provided with an emission driving circuit, and various light effects may be generated via the emission driving circuit. The peripheral device may be, for example, a terminal device such as a display, a mouse, and a keyboard. Specifically, the host may calculate a light controlling instruction according to preset data via a central processing unit (CPU), and drive the emission driving circuit according to the light controlling instruction via a controller and a driver. In this way, based on the light controlling instruction, the emission driving circuit generates a target light effect.

However, since the emission driving circuit generates the light effect based on the light controlling instruction calculated by the central processing unit, the light effect has a certain delay time and is limited to the preset effect without variability. In other words, current peripheral devices are unable to generate the corresponding light effect in real time in response to user requirements.

### SUMMARY OF THE INVENTION

An embodiment of the invention provides an emission controlling circuit suitable for an electronic device that may improve the efficiency and the diversity of the light effect of the electronic device.

An emission controlling circuit of an embodiment of the invention is suitable for controlling a light effect of an electronic device. The electronic device includes a host controlling circuit, an emission driving circuit, and a plurality of terminal devices. The emission controlling circuit includes an accelerator and a controller. The accelerator is coupled to the host controller and the plurality of terminal devices. The accelerator is configured to generate a passive output result according to input data from the plurality of terminal devices. The controller is coupled to the accelerator and the emission driving circuit. The controller is configured to generate a passive controlling instruction according to the passive output result, such that the emission driving circuit drives the plurality of terminal devices based on the passive controlling instruction to generate the light effect.

Based on the above, the emission controlling circuit of an embodiment of the invention generates the passive output result via the accelerator according to the input data provided by the plurality of terminal devices, and may instantly respond to user requirements to obtain the target light effect and control the light effect via the controller accordingly. In this way, the emission controlling circuit may improve the efficiency and the diversity of the electronic device.

In order to make the aforementioned features and advantages of the disclosure more comprehensible, embodiments accompanied with figures are described in detail below.

### BRIEF DESCRIPTION OF THE DRAWINGS

FIG. 1 is a circuit block diagram of an emission controlling circuit shown according to an embodiment of the invention.

FIG. 2 is a circuit block diagram of an emission controlling circuit shown according to another embodiment of the invention.

FIG. 3 is a circuit block diagram of an emission controlling circuit shown according to another embodiment of the invention.

### DESCRIPTION OF THE EMBODIMENTS

A portion of the embodiments of the disclosure is described in detail hereinafter with reference to figures. In the following, the same reference numerals in different figures should be considered to represent the same or similar elements. These embodiments are only a portion of the invention and do not disclose all possible implementations of the invention. Rather, the embodiments are merely examples within the claims of the invention.

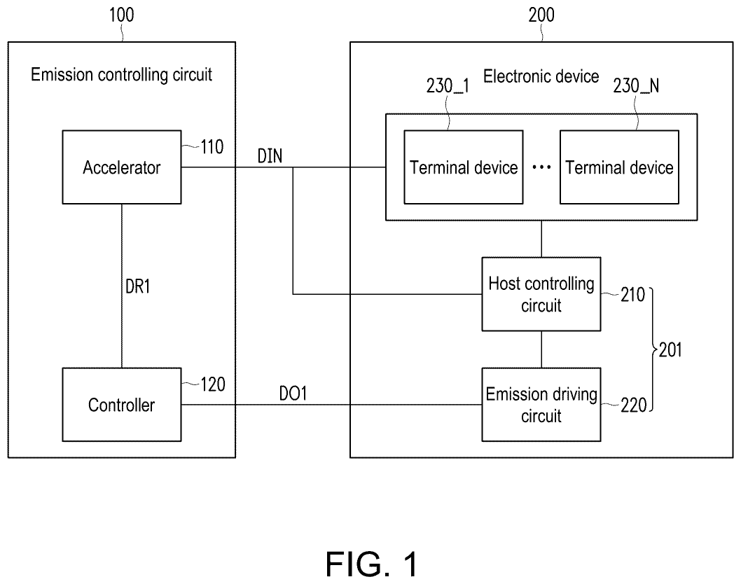

FIG. 1 is a circuit block diagram of an emission controlling circuit shown according to an embodiment of the invention. Referring to FIG. 1, an emission controlling circuit 100 is suitable for controlling the light effect of an electronic device 200, and may achieve the immediacy and the diversity of the light effect. The electronic device 200 may be, for example, an electronic device such as a mobile phone, a computer device, a tablet computer, a notebook computer, and a desktop computer.

In the present embodiment, the electronic device 200 includes a host 201 and a plurality of terminal devices 230_1 to 230_N, wherein N is a positive integer greater than 1. The host 201 includes a host controlling circuit 210 and an emission driving circuit 220. The host controlling circuit 210 is coupled to the emission driving circuit 220 and the plurality of terminal devices 230_1 to 230_N.

In the present embodiment, the host controlling circuit 210 is configured to operate the plurality of terminal devices 230_1 to 230_N to implement various applications. The host controlling circuit 210 may be, for example, a signal converter, a field-programmable gate array (FPGA), a central processing unit (CPU), or other programmable general-purpose or special-purpose microprocessors, digital signal processors (DSPs), programmable controllers, application-specific integrated circuits (ASICs), programmable logic devices (PLDs), or other similar devices or a combination of these devices, which may load and execute computer program-related firmware or software to achieve various computer functions.

In the present embodiment, the plurality of terminal devices 230_1 to 230_N are respectively provided with a plurality of display circuits (not shown). Each of the display circuits is controlled by the emission driving circuit 220. The display circuit may be, for example, a circuit providing a display function such as a liquid-crystal display (LCD), a light-emitting diode (LED), an organic light-emitting diode (OLED).

In the present embodiment, the plurality of terminal devices 230_1 to 230_N are configured to execute various application operations. These terminal devices 230_1 to 230_N may include, for example, input tools such as a microphone, a camera, a touchpad, a stylus, a mouse, or a keyboard, and output tools such as a display or a speaker.

In the present embodiment, the emission driving circuit 220 is controlled by the emission controlling circuit 100. The emission driving circuit 220 is configured to drive a display circuit in the electronic device 200, such as a display circuit included in the plurality of terminal devices 230_1 to 230_N, such that the display circuit generates a target light effect. The emission driving circuit 220 may be, for example, a driver configured to drive the display circuit.

In the present embodiment, the emission controlling circuit 100 includes an accelerator 110 and a controller 120. The accelerator 110 is coupled to the controller 120. The accelerator 110 is also coupled to the host controller 210 and the plurality of terminal devices 230_1 to 230_N. The controller 120 is coupled to the emission driving circuit 220.

In the present embodiment, the accelerator 110 is configured to cooperate with the controller 120 to control the emission driving circuit 220, such that the emission driving circuit 220 drives the display circuits in the plurality of terminal devices 230_1 to 230_N. In the present embodiment, the accelerator 110 may be, for example, an artificial intelligence (AI) accelerator. The controller 120 may be, for example, a red, green, and blue light-emitting diode (RGB LED) controller.

In the application of controlling the light effect, the user may operate one or the plurality of terminal devices 230_1 to 230_N to generate input data DIN. According to the different terminal devices 230_1 to 230_N, the input data DIN has various data formats and data contents. For example, when the operated terminal device 230_1 is a microphone, the input data DIN may be, for example, voice data spoken by the user. When the operated terminal device 230_N is a keyboard, the input data DIN may be typed text data, for example.

Next, the accelerator 110 receives the input data DIN generated from the plurality of terminal devices 230_1 to 230_N. The accelerator 110 generates a passive output result DR1 according to the input data DIN, and outputs the passive output result DR1 to the controller 120. The controller 120 generates a passive controlling instruction DO1 according to the passive output result DR1.

Specifically, the accelerator 110 executes a trained AI model to generate indication data configured to indicate the target light effect according to the input data DIN. The indication data may be represented by the passive output result DR1. The indication data indicates a target device (e.g., one or the plurality of terminal devices 230_1 to 230_N) for generating a light effect, and also indicates the content of the light effect (e.g., flashing once).

Continuing with the above description, the controller 120 converts the passive output result DR1 into an instruction (i.e., the passive controlling instruction DO1). The controller 120 outputs the passive controlling instruction DO1 to the emission driving circuit 220. The emission driving circuit 220 is controlled by the passive controlling instruction DO1, and drives the display circuit in the target device based on the passive controlling instruction DO1. In this way, the plurality of terminal devices 230_1 to 230_N including the display circuit generate the light effect.

For example, when the input data DIN includes voice data of “the number keys light up red”, the accelerator 110 generates the indication data described by the voice data (i.e., the passive output result DR1). That is, the passive output result DR1 instructs the terminal device 230_N (i.e., keyboard) to emit red light on the numeric keys therein. The controller 120 generates the corresponding passive controlling instruction DO1 to control the emission driving circuit 220. Based on the passive controlling instruction DO1, the emission driving circuit 220 drives the display circuit disposed in the terminal device 230_N, such that the display circuit emits red light accordingly.

It is worth mentioning that the accelerator 110 generates indication data (i.e., the passive output result DR1) according to the input data DIN generated by the plurality of terminal devices 230_1 to 230_N. Based on the passive controlling instruction DO1 generated by the controller 120, the emission controlling circuit 100 may intelligently and instantly control the light effect of the electronic device 200 in response to the requirements of the user. In this way, the emission controlling circuit 100 may increase the diversity of the light effect of the plurality of terminal devices 230_1 to 230_N and improve the efficiency of the light effect.

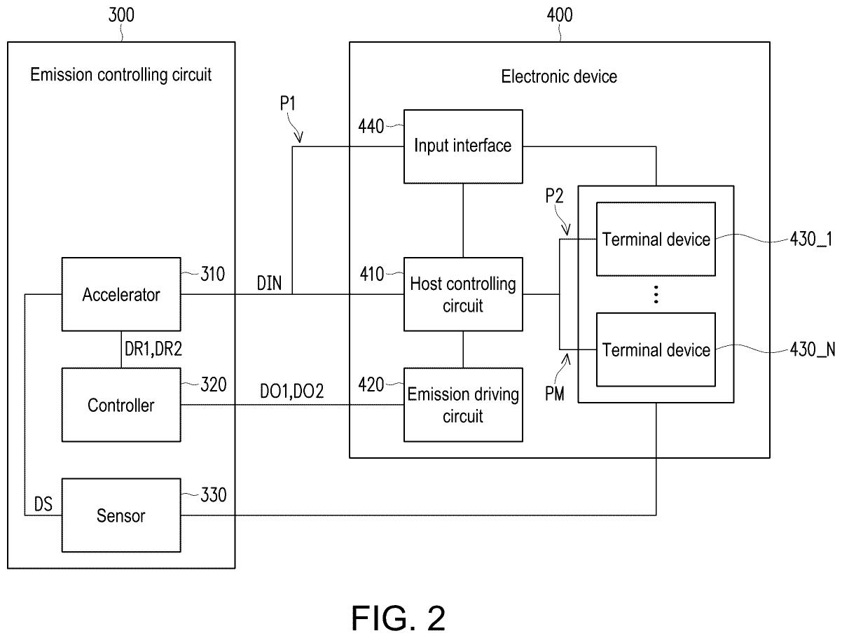

FIG. 2 is a circuit block diagram of an emission controlling circuit shown according to another embodiment of the invention. Referring to FIG. 2, an emission controlling circuit 300 is suitable for controlling the light effect of an electronic device 400. The electronic device 400 includes a host controlling circuit 410, an emission driving circuit 420, and a plurality of terminal devices 430_1 to 430_N. The host controlling circuit 410, the emission driving circuit 420, and the plurality of terminal devices 430_1 to 430_N are as provided in the relevant description of the electronic device 200 and may be deduced by analogy.

In the present embodiment, the electronic device 400 further includes an input interface 440. The input interface 440 is disposed in a host (not shown in FIG. 2) of the electronic device 400. The input interface 440 is coupled to the host controlling circuit 410 and one or the plurality of terminal devices 430_1 to 430_N. The input interface 440 is configured to receive and transmit the input data DIN such as text data and/or voice data input by the plurality of terminal devices 430_1 to 430_N. The input interface 440 may be, for example, an input system console.

In the embodiment of FIG. 2, the emission controlling circuit 300 includes an accelerator 310 and a controller 320. The accelerator 310 and the controller 320 are as provided in the related description of the emission controlling circuit 100 and may be deduced by analogy.

In the application of controlling the light effect, the accelerator 310 receives the input data DIN from the plurality of terminal devices 430_1 to 430_N via a plurality of transmission paths P1 to PM, wherein M is a positive integer greater than 1.

In the present embodiment, the plurality of transmission paths P1 to PM may be, for example, transmission paths independent from each other. The transmission paths P1 to PM are respectively configured to transmit the input data DIN generated by the plurality of terminal devices 430_1 to 430_N to the accelerator 310.

For example, when the operated terminal device 430_1 is a microphone, in the transmission path P1, the input data DIN generated by the terminal device 430_1 is transmitted to the accelerometer 310 via the input interface 440. Alternatively, in the transmission path P2, the input data DIN is transmitted to the accelerator 310 via the host controller 410. For another example, when the operated terminal device 430_N is a mouse, in the transmission path PM, the input data DIN generated by the terminal device 430_N is transmitted to the accelerator 310 via the host controller 410.

It should be noted that, since the accelerator 310 obtains various data operated by the user (i.e., the input data DIN) via the plurality of transmission paths P1 to PM, the accelerator 310 is able to execute the trained AI model to analyze user behavior and generate the passive output result DR1 accordingly. In this way, based on the passive controlling instruction DO1 corresponding to user behavior, the emission controlling circuit 300 may intelligently control the light effect of the emission driving circuit 420.

Compared with the embodiment of FIG. 1, in the embodiment of FIG. 2, the emission controlling circuit 300 further includes at least one sensor 330. The sensor 330 is coupled to the accelerator 310 and the plurality of terminal devices 430_1 to 430_N. The sensor 330 is configured to sense the state of the electronic device 400 to generate a sensing signal DS, and output the sensing signal DS to the accelerator 310.

In the present embodiment, the state of the electronic device 400 may be, for example, the temperature of the electronic device 400 and various operation data of the plurality of terminal devices 430_1 to 430_N. The operation data includes, for example, the face image received by the terminal device 430_i (e.g., a camera), and current data such as click frequency and/or movement speed of the terminal device 430_N (e.g., a mouse). Correspondingly, the sensing signal DS may be, for example, a signal such as a temperature sensing signal, a light sensing signal, a vibration sensing signal.

In the application of controlling the light effect, the accelerator generates an active output result DR2 according to the sensing signal DS, and outputs the active output result DR2 to the controller 320. The controller 320 generates an active controlling instruction DO2 according to the active output result DR2.

Specifically, the accelerator 310 executes a trained AI model to generate indication data for indicating the target light effect according to the sensing signal DS. The indication data may be represented by the active output result DR2. The indication data indicates the target device (e.g., one or the plurality of terminal devices 430_1 to 430_N) generating the light effect when the sensing signal DS meets a preset condition, and also indicates the content of the light effect (e.g., flashing once).

Continuing with the above description, the controller 320 converts the active output result DR2 into an instruction (i.e., the active controlling instruction DO2). The controller 320 outputs the active controlling instruction DO2 to the emission driving circuit 420. The emission driving circuit 420 is controlled by the active controlling instruction DO2 and drives the display circuit in the target device based on the active controlling instruction DO2. In this way, the plurality of terminal devices 430_1 to 430_N including the display circuit generate the light effect.

For example, when the sensing signal DS includes a face image, the accelerator 310 identifies whether the user corresponding to the face image is a registered account (i.e., a preset condition) to generate a determination result. When the determination result is yes, the accelerator 310 generates the active output result DR2. That is, when the face image matches the account, the active output result DR2 may instruct the plurality of terminal devices 430_1 (i.e., keyboard) and 430_N (i.e., mouse) to emit green light simultaneously. The controller 320 generates the corresponding active controlling instruction DO2 to control the emission driving circuit 420. Based on the active controlling instruction DO2, the emission driving circuit 420 drives the plurality of display circuits disposed in the plurality of terminal devices 430_1 and 430_N to make the display circuits emit green light accordingly.

For another example, when the sensing signal DS includes the click frequency of the mouse, the accelerator 310 determines whether the click frequency is greater than a threshold (i.e., a preset condition) to generate a determination result. When the determination result is yes, the accelerator 310 generates the active output result DR2. That is, when the click frequency of the mouse is greater than a threshold (e.g., 2 times), the active output result DR2 may indicate that the terminal device 430_N (i.e., the mouse) flashes once. The controller 320 generates the corresponding active controlling instruction DO2 to control the emission driving circuit 420. Based on the active controlling instruction DO2, the emission driving circuit 420 drives the display circuit disposed in the terminal device 430_N to make the display circuit flash once.

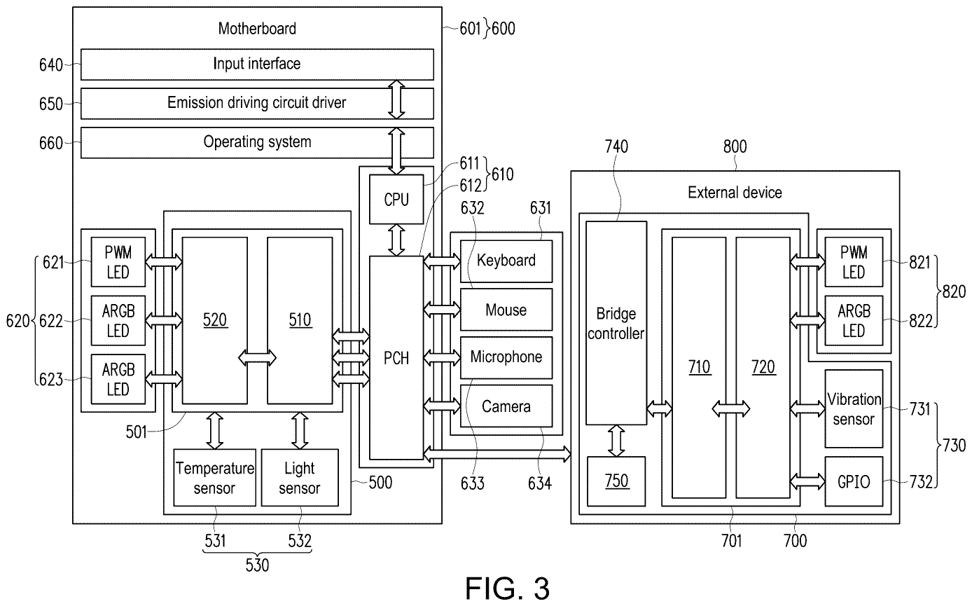

FIG. 3 is a circuit block diagram of an emission controlling circuit shown according to another embodiment of the invention. Referring to FIG. 2, an emission controlling circuit 500 is suitable for controlling the light effect of an electronic device 600. The electronic device 600 includes a host controlling circuit 610, an emission driving circuit 620, a plurality of terminal devices 631 to 634, and an input interface 640. The host controlling circuit 610, the emission driving circuit 620, the plurality of terminal devices 631 to 634, and the input interface 640 are as provided in the relevant description of the electronic device 400 and may be deduced by analogy.

In the embodiment of FIG. 3, the host controlling circuit 610 is implemented as an integrated circuit, for example. The host controlling circuit 610 includes a central processing unit 611 and a platform controller hub (PCH) 612. The central processing unit 611 is coupled to the PCH 612. The central processing unit 611 is also coupled to the emission controlling circuit 500 and the plurality of terminal devices 631 to 634 via the PCH 612.

In the present embodiment, the plurality of terminal devices 631 to 634 are externally connected to a motherboard 601 in a wireless or wired manner. These terminal devices 631 to 634 include, for example, a keyboard 631, a mouse 632, a microphone 633, and a camera 634.

In the present embodiment, the emission driving circuit 620 is implemented by, for example, an integrated circuit. The emission driving circuit 620 includes a pulse-width modulation (PWM) LED controller 621 and a plurality of addressable LED (ARGB) controllers 622 to 623, wherein the number of the ARGB controllers 622 to 623 is only for illustration.

In the present embodiment, the electronic device 600 further includes an emission driving circuit driver 650 and an operating system 660. The input interface 640, the emission driving circuit driver 650, the operating system 660, the emission driving circuit 620, and the host controlling circuit 610 are all disposed on the motherboard 601 of a host (not shown in FIG. 3). The input interface 640 is coupled to the host controlling circuit 610 via the emission driving circuit driver 650 and the operating system 660. The emission driving circuit driver 650 may be, for example, a red, green, and blue LED (RGB LED) driver.

In the embodiment of FIG. 3, the emission controlling circuit 500 includes an accelerator 510, a controller 520, and a sensor 530. The accelerator 510, the controller 520, and the sensor 530 are as provided in the related description of the emission controlling circuit 300 and may be deduced by analogy.

In the present embodiment, the accelerator 510 and the controller 520 are integrated into an integrated circuit 501. The integrated circuit 501 is disposed on the motherboard 601. The integrated circuit 501 is coupled to the host controlling circuit 610 and the emission driving circuit 620.

Specifically, the integrated circuit 501 and the host controlling circuit 610 are coupled to each other via a plurality of transmission circuits. The plurality of transmission circuits include, for example, a USB transmission circuit, an Inter-Integrated Circuit (I2C), and a plurality of general-purpose input/output (GPIO) pins. That is, the accelerator 510 is coupled to the PCH 612 via the plurality of transmission circuits, and is also coupled to the central processing unit 611 via the PCH 612.

In the present embodiment, the sensor 530 includes a temperature sensor 531 and a light sensor 532. The sensors 531 to 532 are disposed on the motherboard 601 and coupled to the integrated circuit 501. In some embodiments, the sensors 531 to 532 are integrated into the integrated circuit 501.

In the application of controlling the light effect, the temperature sensor 531 senses the current temperature of the motherboard 601 to generate a temperature sensing signal (e.g., the sensing signal DS shown in FIG. 2). The temperature sensor 531 outputs a temperature sensing signal to the accelerator 510. In addition, the light sensor 532 senses a face image approaching the electronic device 600, or senses a fingerprint image touching the electronic device 600, to generate a light sensing signal (e.g., the sensing signal DS shown in FIG. 2). The light sensor 532 outputs a light sensing signal to the accelerator 510.

In this way, the accelerator 510 generates an active output result (e.g., the active output result DR2 shown in FIG. 2) according to the temperature sensing signal, the light sensing signal, or a combination thereof, and outputs the active output result to the controller 520. The controller 520 generates an active controlling instruction (e.g., the active controlling instruction DO2 shown in FIG. 2) according to the active output result.

Specifically, the accelerator 510 executes the trained AI model to generate indication data (i.e., active output result) for indicating the target light effect according to the desired temperature sensing signal and/or light sensing signal. The controller 520 outputs an active controlling instruction to the emission driving circuit 620 according to the active output result. The emission driving circuit 620 is controlled by the active controlling instruction and drives the display circuit in the target device based on the active controlling instruction. In this way, the plurality of terminal devices 631 to 634 including the display circuit generate a light effect.

In the embodiment of FIG. 3, the electronic device 600 may be further connected to one or a plurality of external devices 800. The external device 800 may be, for example, a USB device. The external device 800 includes an emission driving circuit 820. The emission driving circuit 820 is implemented by, for example, an integrated circuit. The emission driving circuit 820 includes a PWM LED controller 821 and one or a plurality of ARGB controllers 822.

In addition, the external device 800 further includes an emission controlling circuit 700. The emission controlling circuit 700 is suitable for controlling the light effect of the electronic device 600. The emission controlling circuit 700 includes an accelerator 710, a controller 720, and a sensor 730. The accelerator 710, the controller 720, and the sensor 730 are as provided in the related description of the emission controlling circuit 300 and may be deduced by analogy.

In the present embodiment, the emission controlling circuit 700 further includes a bridge controller 740 and a memory 750. Moreover, the accelerator 710 and the controller 720 are integrated into an integrated circuit 701. The integrated circuit 701 is coupled to the electronic device 600 and the emission driving circuit 820.

In detail, the integrated circuit 701 disposed in the external device 800 is coupled to the bridge controller 740. The bridge controller 740 is coupled to the host controlling circuit 610 via the USB transmission circuit. The bridge controller 740 may be, for example, a USB bridge controller bridging the integrated circuit 701 and the host controlling circuit 610 based on the USB specification. The integrated circuit 701 is also coupled to the memory 750 via the bridge controller 740.

In the present embodiment, the sensor 730 includes at least one vibration sensor 731. The vibration sensor 731 is coupled to the integrated circuit 701. In some embodiments, the vibration sensor 731 is integrated into the integrated circuit 701.

In the application of controlling the light effect, the vibration sensor 731 senses the operating states of the plurality of terminal devices 631 to 634 to generate a vibration sensing signal (e.g., the sensing signal DS shown in FIG. 2). The vibration sensor 731 outputs a vibration sensing signal to the accelerator 710. The accelerator 710 generates an active output result (e.g., the active output result DR2 shown in FIG. 2) according to the vibration sensing signal. The controller 720 generates an active controlling instruction (e.g., the active controlling instruction DO2 shown in FIG. 2) according to the active output result.

Specifically, the accelerator 710 executes a trained AI model to generate indication data (i.e., active output result) configured to indicate the target light effect according to the vibration sensing signal. The controller 720 outputs an active controlling instruction to the emission driving circuit 820 according to the active output result. The emission driving circuit 820 is controlled by the active controlling instruction and drives the display circuit in the target device based on the active controlling instruction. In this way, the plurality of terminal devices 631 to 634 including the display circuit generate a light effect.

In the present embodiment, the accelerator 710 may also receive a sensing signal outputted from other sensors via the interface circuit 732 of the integrated circuit 701. The other sensors may include, for example, the temperature sensor 531 and the light sensor 532 disposed on the motherboard 601. The interface circuit 732 may be, for example, a GPIO interface circuit. In this way, the accelerometer 710 and the controller 720 may implement the above application of controlling the light effect based on the sensing signal.

Based on the above, the emission controlling circuit of an embodiment of the invention calculates the input data from the plurality of terminal devices via the accelerator to reduce the response time and the delay needed by the controller, thereby accelerating the application of the light effect. In addition, the emission controlling circuit may also generate indication data of the light effect in response to user needs based on user behavior. In this way, the emission controlling circuit may intelligently and instantly control the light effect of the electronic device, thereby improving the efficiency and the diversity of the light effect of the electronic device.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. An emission controlling circuit, suitable for controlling a light effect of an electronic device, wherein the electronic device comprises a host controlling circuit, an emission driving circuit, and a plurality of terminal devices, and the emission controlling circuit comprises:
an accelerator coupled to the host controller and the terminal devices and configured to generate a passive output result according to input data from the terminal devices; and
a controller coupled to the accelerator and the emission driving circuit and configured to generate a passive controlling instruction according to the passive output result, such that the emission driving circuit drives the terminal devices based on the passive controlling instruction to generate the light effect.

2. The emission controlling circuit of claim 1, wherein the accelerator receives the input data from the terminal devices via a plurality of transmission paths.

3. The emission controlling circuit of claim 1, further comprising:
at least one sensor coupled to the accelerator and the terminal devices and configured to generate a sensing signal,
wherein the accelerator generates an active output result according to the sensing signal, and the controller generates an active controlling instruction according to the active output result, such that the emission driving circuit drives the terminal devices based on the active controlling instruction to generate the light effect.

4. The emission controlling circuit of claim 1, wherein the accelerator and the controller are integrated into an integrated circuit, and the integrated circuit and the host controlling circuit are disposed on a motherboard of the electronic device.

5. The emission controlling circuit of claim 4, wherein the accelerator is coupled to the host controlling circuit via a universal serial bus (USB) transmission circuit, an inter-integrated circuit (I2C), and a plurality of general-purpose input/output (GPIO) pins.

6. The emission controlling circuit of claim 4, further comprising:
a temperature sensor coupled to the integrated circuit and configured to generate a temperature sensing signal; and
a light sensor coupled to the integrated circuit and configured to generate a light sensing signal,
wherein the accelerator generates an active output result according to at least one of the temperature sensing signal and the light sensing signal, and the controller generates an active controlling instruction according to the active output result, such that the emission driving circuit drives the terminal devices based on the active controlling instruction to generate the light effect.

7. The emission controlling circuit of claim 1, wherein the accelerator and the controller are integrated into an integrated circuit, and the integrated circuit is disposed in an external device configured to be externally connected to the electronic device.

8. The emission controlling circuit of claim 7, further comprising:
a bridge controller coupled to the integrated circuit and coupled to the host controlling circuit via a universal serial bus (USB) transmission circuit.

9. The emission controlling circuit of claim 7, further comprising:
at least one vibration sensor coupled to the integrated circuit and configured to generate a vibration sensing signal,
wherein the accelerator generates an active output result according to the vibration sensing signal, and the controller generates an active controlling instruction according to the active output result, such that the emission driving circuit drives the terminal devices based on the active controlling instruction to generate the light effect.

10. The emission controlling circuit of claim 1, wherein the accelerator is an artificial intelligence (AI) accelerator.
